(19) United States
(12) Patent Application Publication
(10) Pub. No.: US 2026/0011842 A1
(43) Pub. Date: Jan. 8, 2026

(54) BATTERY PACK

(71) Applicant: TOYOTA JIDOSHA KABUSHIKI KAISHA, Toyota-shi (JP)

(72) Inventor: Hiroshi OTAKE, Toyota-shi (JP)

(73) Assignee: TOYOTA JIDOSHA KABUSHIKI KAISHA, Toyota-shi (JP)

(21) Appl. No.: 19/235,712

(22) Filed: Jun. 12, 2025

(30) Foreign Application Priority Data
Jul. 4, 2024 (JP) 2024-108351

(51) Int. Cl. H01M 50/242; B60L 50/64; H01M 10/613; H01M 10/625; H01M 10/656; H01M 50/204; H01M 50/249

(52) U.S. Cl. CPC H01M 50/242; B60L 50/64; H01M 10/613; H01M 10/625; H01M 10/656; H01M 50/204; H01M 50/249; H01M 2220/20

(57) ABSTRACT

Provided is a battery pack capable of improving protection performance for a battery module. A battery pack according to an aspect of the present disclosure includes a battery module, a case housing the battery module, and a cooling pipe, in which the case includes a side plate disposed along a side surface of the battery module, the side plate includes a spatial region formed in a region different from an installation region of an impact absorbing member installed on an outer surface of the side plate, and the cooling pipe is disposed in the spatial region. Therefore, the battery pack according to an aspect of the present disclosure is a battery pack in 10 which the clamp for fixing the cooling pipe and the cooling pipe are less apt to interfere with the battery module even when the battery pack is impacted from its side.

### CROSS REFERENCE TO RELATED APPLICATIONS

This application is based upon and claims the benefit of priority from Japanese patent application No. 2024-108351, filed on Jul. 4, 2024, the disclosure of which is incorporated herein in its entirety by reference.

### BACKGROUND

The present disclosure relates to a battery pack.

Patent Literature 1 discloses a battery pack having a structure capable of suppressing contact of a support member for supporting a device pedestal from below with a battery stack even when the battery pack is impacted from its side. In this battery pack, a cooling pipe is provided in a space surrounded by a stack pedestal, a battery stack, and a stack bracket.

Patent Literature 1: Japanese Unexamined Patent Application Publication No. 2022-137537

### SUMMARY

However, in a battery pack disclosed in Patent Literature 1, there is a problem that when the battery pack is impacted from its side, the battery stack and the cooling pipe may interfere with each other, and the protection performance of the battery stack (the battery module) deteriorates.

The present disclosure has been made in view of the above problem, and provides a battery pack having an improved protection performance for a battery module.

According to an aspect of the present disclosure, a battery pack includes: a battery module; case for housing the battery module; and a cooling pipe, in which the case includes a side plate disposed along a surface of the battery module, the side plate includes a spatial region formed in a region different from an installation region of an impact absorbing member installed on an outer surface of the side plate, and the cooling pipe is disposed in the spatial region. Therefore, in the aforementioned battery pack, an interference between the cooling pipe, the clamp fixing the cooling pipe, and the battery module can be prevented even when the battery pack is impacted from its side, whereby protection performance of the battery pack for the battery module can be improved.

According to the present disclosure, a battery pack having an improved protection performance for a battery module can be provided.

The above and other objects, features and advantages of the present disclosure will become more fully understood from the detailed description given hereinbelow and the accompanying drawings.

### BRIEF DESCRIPTION OF DRAWINGS

FIG. 1 is a top surface diagram of a battery pack according to an embodiment of the present disclosure;

FIG. 2 is a cross-sectional view of a battery pack according to an embodiment of the present disclosure; and

FIG. 3 is a cross-sectional view of a battery pack according to an embodiment of the present disclosure.

### DESCRIPTION OF EMBODIMENTS

Specific embodiments of the present disclosure will now be described in detail with reference to the drawings. However, the present disclosure is not limited to the following embodiments. For clarity of explanation, the following descriptions and drawings have been simplified as appropriate.

### Configuration of Battery Pack

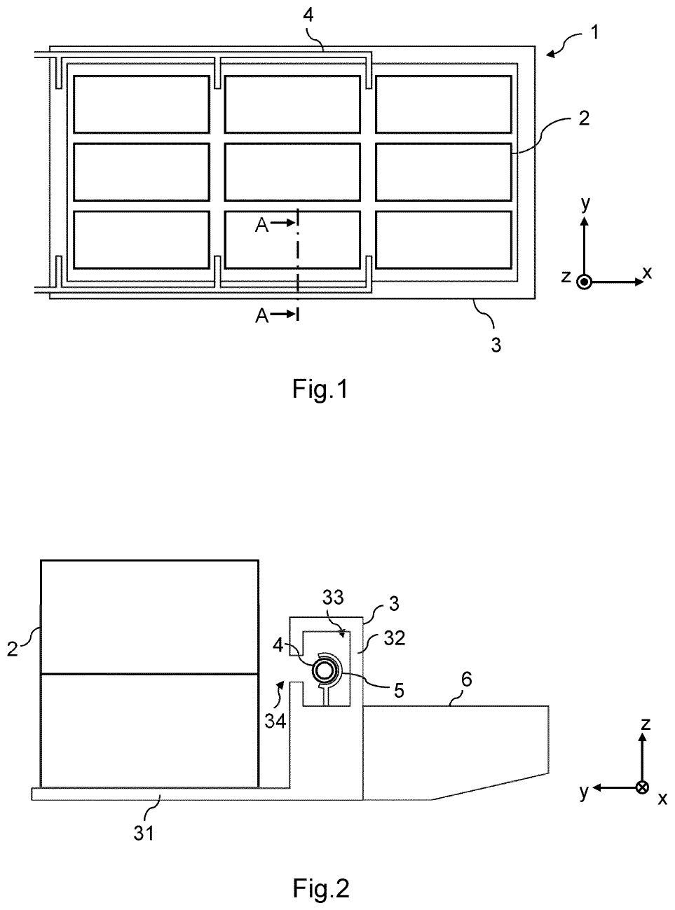

FIG. 1 is a top surface diagram of a battery pack 1 according to an embodiment of the present disclosure. The battery pack 1 is disposed in a vehicle such that, for example, the x-axis direction expresses the longitudinal direction of the battery pack 1 which is the front-rear direction of the vehicle, the y-axis direction expresses the transverse direction of the battery pack 1 which is the left-right direction of the vehicle, and the z-axis direction expresses the height direction of the battery pack 1 which is the height direction of the vehicle.

FIG. 2 is a cross-sectional view of the battery pack 1 according to an embodiment of the present disclosure. In the example of FIG. 2, the battery pack 1 taken along the A-A cross-section shown in FIG. 1 is shown. An impact absorbing member 6 is also shown in FIG. 2.

The right-handed xyz orthogonal coordinates shown in FIGS. 1 and 2 are for the convenience in illustrating the positional relationship of the structural elements/components. In FIGS. 1 and 2, the z-axis positive direction is a vertically upward direction and the xy-plane is a horizontal plane, which are common throughout the drawings.

As shown in FIGS. 1 and 2, the battery pack 1 includes a battery module 2, a case 3, a cooling pipe 4, and a pipe fixing clamp 5.

The battery module 2 includes a plurality of laminated battery cells electrically connected to each other. Each battery cell is, for example, a lithium-ion battery, a lead-acid battery, or a nickel-metal hydride battery, and configured by housing a negative electrode layer, a positive electrode layer, a separator, etc., in a rectangular-parallelepiped case, but is not limited thereto. In the examples of FIGS. 1 and 2, a plurality of the battery modules 2 are disposed so as to be in contact with a top surface of a bottom part 31 of the case 3. At this time, a plurality of the battery modules 2 may be stacked in the positive z-axis direction.

The case 3 includes the bottom part 31 and a side plate 32. A spatial region 33 is provided inside the side plate 32. The side plate 32 is provided with an opening part 34 configured in such a way that the spatial region 33 is open toward the battery module 2. The bottom part 31 is also referred to as a bottom plate. The side plate 32 is also referred to as a side wall part.

The case 3 may include a top surface part covering a top surface of the battery module 2. The material and the shape of top surface part are not particularly limited. The top surface part is also referred to as a top plate. The case 3 may be made of, for example, a steel sheet, an aluminum alloy, carbon fiber reinforced plastics (CFRP), a glass fiber (GF), etc., but the material of the case 3 is not limited to these materials.

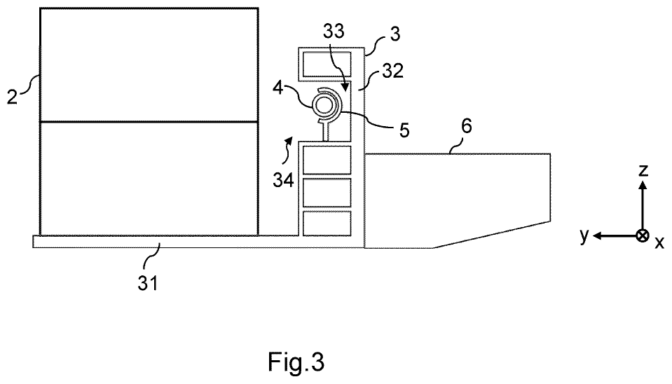

As long as the side plate 32 has the spatial region 33, the structure and the thickness of the side plate 32 are not particularly limited. For example, as shown in FIG. 3, the side plate 32 may have a configuration having a side frame consisting of a grid-like frame and a flat plate. In this case, the spatial region 33 is a region surrounded by the frame and the flat plate.

The cooling pipe 4 is connected to a cooler (not shown) and cools the battery module 2 by flowing coolant inside the cooling pipe 4. The cooling pipe 4 is disposed in the spatial region 33. However, a part of the cooling pipe 4 may be located outside the spatial region 33 to be connected to a cooler and other facilities installed outside the battery pack 1. The cooling pipe 4 may be made of, for example, an aluminum alloy, resin, plastic, etc., but the material of the cooling pipe 4 is not limited to these materials.

Thus, in the battery pack 1 according to the present disclosure, by disposing the cooling pipe 4 in the spatial region 33 inside the side plate 32, space saving can be realized compared with the case where the cooling pipe 4 is disposed outside the side plate 32, and consequently, whereby size reduction of the battery pack can be realized. In addition, in the battery pack 1 according to the present disclosure, by disposing the cooling pipe 4 in the spatial region 33 inside the side plate 32, interference between the cooling pipe 4 and the battery module 2 can be prevented even when the battery pack is impacted from its side, whereby protection performance of the battery pack 1 for the battery module 2 can be improved.

The cooling pipe 4 may be fixed in the spatial region 33 by the pipe fixing clamp 5. In the example shown in FIG. 2, the cooling pipe 4 is fixed by the pipe fixing clamp 5 attached to the bottom part of the spatial region 33. However, the method of fixation of the cooling pipe 4 is not particularly limited. For example, the cooling pipe 4 may be fixed by the pipe fixing clamp 5 attached to the side surface or the top surface of the spatial region 33. Alternatively, the cooling pipe 4 may be fixed to the side plate 32 by welding or the like without using the pipe fixing clamp 5. Alternatively, the cooling pipe 4 may be fixed by combining these fixation methods.

In the example of FIG. 2, one cooling pipe 4 is disposed in the spatial region 33, but a plurality of cooling pipes 4 may be disposed. In addition, while the cooling pipe 4 is disposed in the x-axis direction in the example of FIG. 1, the cooling pipe 4 may be disposed in the y-axis direction or in the x- and y-axis directions.

Thus, in the battery pack 1 according to the present disclosure, by disposing the cooling pipe 4 and the pipe fixing clamp 5 in the spatial region 33 inside the side plate 32, the protection performance of the battery pack 1 for the battery module 2 can be improved even when the battery pack is impacted from its side.

Preferably, the cooling pipe 4 is disposed at the same height as the height of the opening part 34 of the side plate 32 in the spatial region 33. As a result, the side plate 32 being a hindrance between the cooling pipe 4 and the opening part 34 is eliminated, and the cooling performance for the battery module 2 by the cooling pipe 4 is improved. In addition, the spatial region 33 in which the cooling pipe 4 is disposed at a height different from the height of the impact absorbing member 6 provided in an outer surface of the side plate 32. In other words, the spatial region 33 in which the cooling pipe 4 is disposed at a height different from the height of the installation region of the impact absorbing member 6 in the outer surface of the side plate 32.

By disposing the spatial region 33 in which the cooling pipe 4 is disposed at a height from height of the impact absorbing member 6, the impact from the outside via the impact absorbing member 6 on the battery pack is hardly transmitted directly to the spatial region 33. Therefore, deformation of the case 3 can be prevented.

The impact absorbing member 6 is disposed at a height from the height of the spatial region 33 on the outer surface of the side plate 32. Here, the impact absorbing member 6 is disposed on the lower side of the spatial region 33 in the height direction, but may be disposed on the upper side of the spatial region 33 in the height direction. For example, iron or aluminum is used for the impact absorbing member 6, but the material, the structure and the thickness of the impact absorbing member 6 in the xy-plane direction are not particularly limited.

As described above, in the battery pack 1 according to one embodiment of the present disclosure, by disposing the cooling pipe 4 in the spatial region 33 inside the side plate 32 of the case 3 that houses the battery module 2, interference between the cooling pipe 4 and the battery module 2 can be prevented even when the battery pack is impacted from its side, whereby the protection performance of the battery pack 1 for the battery module 2 can be improved.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack, comprising:
a battery module;
a case for housing the battery module; and
a cooling pipe, wherein
the case includes a side plate disposed along a side surface of the battery module,
the side plate includes a spatial region formed in a region different from an installation region of an impact absorbing member installed on an outer surface of the side plate, and
the cooling pipe is disposed in the spatial region.

2. The battery pack according to claim 1, wherein the side plate includes an opening part configured in such a way that the spatial region is open toward the battery module.

3. The battery pack according to claim 1, wherein the spatial region in which the cooling pipe is disposed is formed on an upper side of the installation region of the impact absorbing member in a height direction.

4. The battery pack according to claim 1, wherein in the case where the battery pack is housed in a vehicle, the side plate is disposed to face the battery module in a horizontal direction.
